(19) United States
(12) Patent Application Publication
(10) Pub. No.: US 2024/0150157 A1
(43) Pub. Date: May 9, 2024

(54) Lifting Device

(71) Applicants: MAEBASHI INSTITUTE OF TECHNOLOGY, Maebashi-shi, Gunma (JP); SANDEN RETAIL SYSTEMS CORPORATION, Isesaki-shi, Gunma (JP)

(72) Inventors: Chi ZHU, Maebashi-shi, Gunma (JP); Peirng LI, Maebashi-shi, Gunma (JP); Hideki KIMURA, Isesaki-shi, Gunma (JP); Mototaka TAJIKA, Isesaki-shi, Gunma (JP); Masaru TSUNODA, Isesaki-shi, Gunma (JP)

(21) Appl. No.: 18/281,510

(22) PCT Filed: Feb. 16, 2022
(86) PCT No.: PCT/JP2022/006111

§ 371 Date: Sep. 11, 2023

(30) Foreign Application Priority Data
Mar. 26, 2021 (JP) 2021-052879
Mar. 26, 2021 (JP) 2021052879

(51) Int. Cl. B66F 7/06

(52) U.S. Cl. CPC B66F 7/0666; B66F 7/0608

(57) ABSTRACT

The drive device of the lifting apparatus includes an electric actuator 91, a movable part 93 that is driven and moved by an electric actuator 91, a first link member 951L (951R), a second link member 953L (953R) rotatably coupled to the first link member 951L (951R) via a shaft member 952L (952R), and a guide member 97L (97R) having a guide hole 971L (971R) for guiding the shaft member 952L (952R) that moves with the movement of the movable part 93. The lifting platform 50 is raised and lowered by vertically extending and retracting a pair of lower right and left X-shaped arms 71L (71R) and a pair of upper right and left X-shaped arms 75L (75R) via the first link member 951L and second link member 953L along with movement of the movable part 93.

### TECHNICAL FIELD

The present invention relates to a lifting apparatus that raises and lowers a lifting platform by vertically extending and retracting a pair of right and left X-shaped arms.

### BACKGROUND ART

Patent document 1 discloses an example of a technique that raises and lowers its loading platform (lifting platform) by extending and retracting its lifting arms (X-shaped arms) using its electric cylinder.

### REFERENCE DOCUMENT LIST

### Patent Document

Patent Document 1: JP 2010-274704 A

### SUMMARY OF THE INVENTION

### Problem to be Solved by the Invention

When a lifting platform is raised and lowered by extending and retracting X-shaped arms, normally, more power is needed to raise the lifting platform located at its lowest position than to raise the lifting platform located at any other positions. Thus, if an electric actuator such as an electric cylinder is used as a drive source to extend and retract the X-shaped arms, it is necessary to adopt an electric actuator that can produce an output sufficient for raising the lifting platform which is located at its lowest position. That is, it has been difficult to reduce the size of the electric actuator.

Thus, an object of the present invention is to provide a lifting apparatus that can be equipped with a smaller electric actuator.

### Means for Solving the Problem

In one aspect of the present invention, a lifting apparatus is provided that raises and lowers a lifting platform by vertically extending and retracting a pair of right and left X-shaped arms with a drive device. In this lifting apparatus, the drive device comprises an electric actuator, a movable part that is driven and moved by the electric actuator, a first link member having one end that is rotatably coupled to the movable part, a second link member having one end that is rotatably coupled to the pair of right and left X-shaped arms and having another end that is rotatably coupled to another end of the first link member via a shaft member, and a guide member having a guide part for guiding the shaft member that moves with movement of the movable part. In addition, the drive device is constructed to vertically extend and retract the pair of right and left X-shaped arms via the first link member and the second link member along with movement of the movable part.

### Effects of the Invention

According to the present invention, there is provided a lifting apparatus that can be equipped with a smaller electric actuator.

### BRIEF DESCRIPTION OF THE DRAWINGS

FIG. 1 is a front view of a lifting apparatus according to an example of the present invention.

FIG. 2 is a rear view of the lifting apparatus.

FIG. 3 is a view of the lifting apparatus from the right.

FIG. 4 is a view of the lifting apparatus from the left when a pair of right and left plates are removed.

FIG. 5 is a view of an extendable mechanism of the lifting apparatus from the right.

FIG. 6 is a view of the extendable mechanism from the left.

FIG. 7 is a perspective view of the extendable mechanism.

FIG. 8 is a view of a drive device of the lifting apparatus from the right.

FIG. 9 is a view of the drive device from the left.

FIG. 10 is a top view seen from an arrow A in FIG. 8.

FIG. 11 illustrates another shape of a guide hole in a guide member of the drive device.

FIG. 12 illustrates an operation example of the lifting apparatus, and the state of the extendable mechanism and the drive device 90 when the lifting platform is located at its lowest position.

FIG. 13 illustrates an operation example of the lifting apparatus, and the state of the extendable mechanism and the drive device when the lifting platform is located at an intermediate position.

FIG. 14 illustrates an operation example of the lifting apparatus, and the state of the extendable mechanism and the drive device when the lifting platform is located at its highest position.

FIG. 15 illustrates a result of a comparison between the lifting apparatus and a conventional lifting apparatus of the same kind.

### MODE FOR CARRYING OUT THE INVENTION

Hereinafter, an example of the present invention will be described with reference to the accompanying drawings.

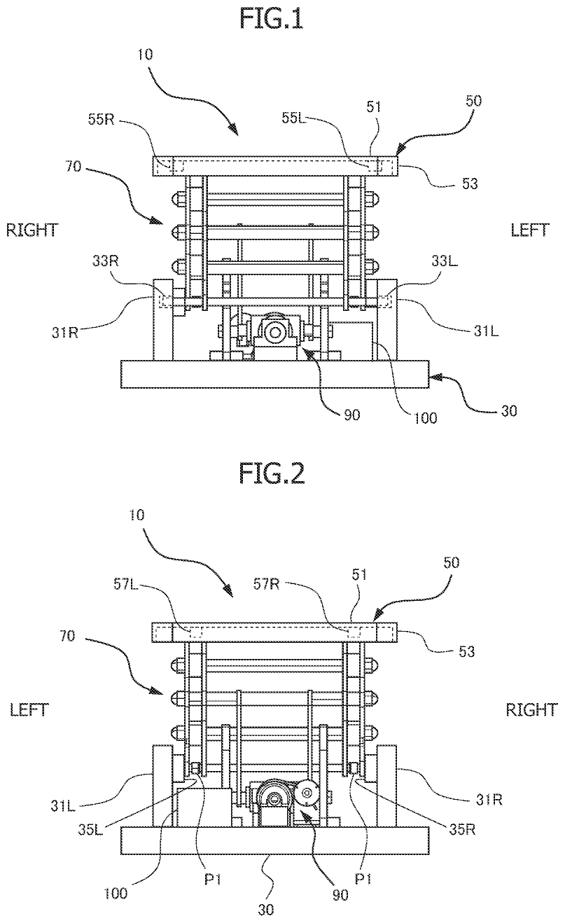

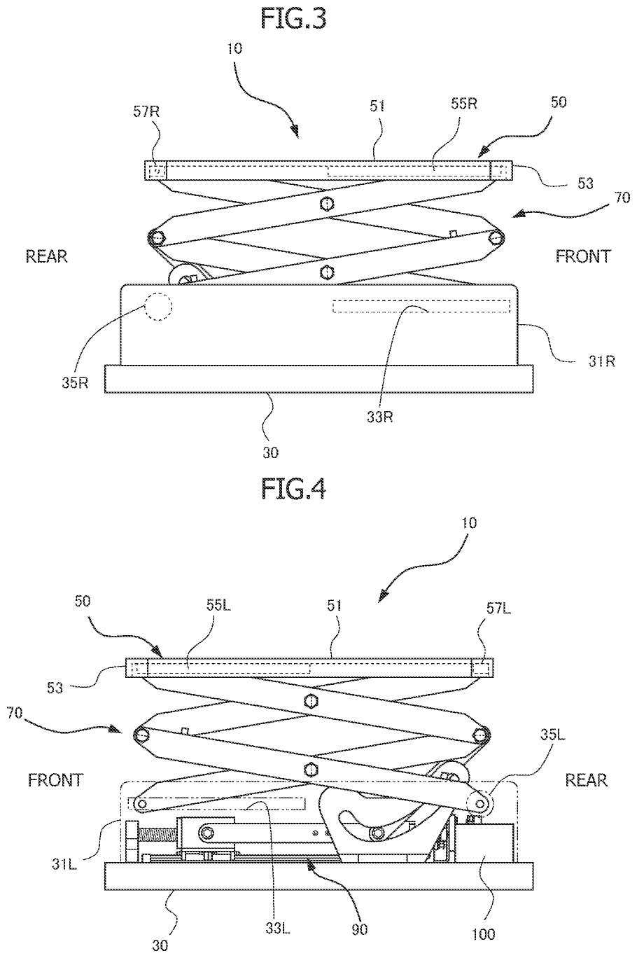

FIGS. 1 to 4 illustrate the construction of a lifting apparatus 10 according to an example of the present invention. FIG. 1 is a front view of the lifting apparatus 10, and FIG. 2 is a rear view of the lifting apparatus 10. FIG. 3 is a view of the lifting apparatus 10 from the right, and FIG. 4 is a view of the lifting apparatus 10 from the left when a pair of right and left plates (a left plate 31L and a right plate 31R) are removed, which will be described later. Note that the left plate 31L is indicated by a two-dot chain line in FIG. 4.

The lifting apparatus 10 according to this example includes a base 30, a lifting platform 50 that is disposed above the base 30, an extendable mechanism 70 disposed between the base 30 and the lifting platform 50, a drive device 90 that drives (extends and retracts) the extendable mechanism 70, and a control device 100 that includes a power supply and a control circuit.

The base 30 is formed as a rectangular plate. The pair of right and left plates (the left plate 31L and the right plate 31R) that support the extendable mechanism 70 is formed on the top surface of the base 30. The pair of side plates (the left plate 31L and the right plate 31R) are disposed spaced apart from each other laterally, each of which extends longitudinally.

The lifting platform 50 has a rectangular top board part 51, and a load (not illustrated) or the like is placed on the top surface of the top board part 51. The lifting platform 50 also has a peripheral wall part 53 extending downward from the peripheral part of the top board part 51.

The extendable mechanism 70 includes a pair of right and left X-shaped arms (also referred to as “pantograph arms”), and is constructed to vertically extend and retract the pair of right and left X-shaped arms and to raise and lower the lifting platform 50 in parallel to the base 30. Here, the base 30 is normally placed on a horizontal surface. That is, by extending and retracting the pair of right and left X-shaped arms vertically, the extendable mechanism 70 can horizontally raise and lower the lifting platform 50. According to the present example, the extendable mechanism 70 is formed as an X-shaped link mechanism in which two right X-shaped arms are vertically stacked one on the other and two left X-shaped arms are vertically stacked one on the other.

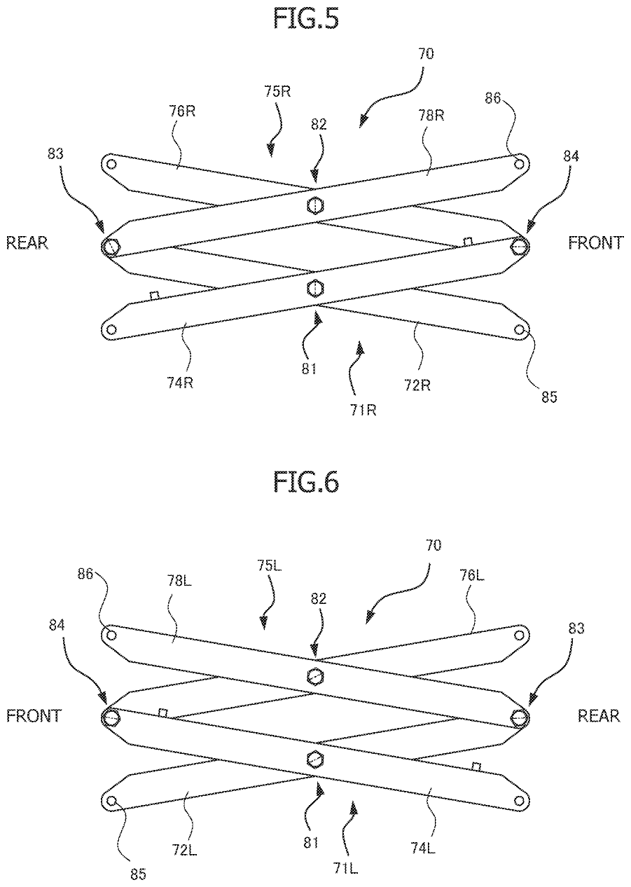

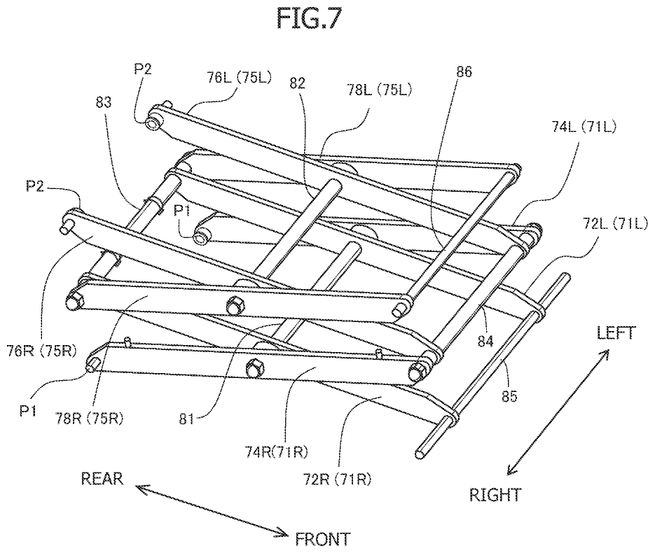

FIGS. 5 to 7 illustrate the construction of the extendable mechanism 70. FIG. 5 is a view of the extendable mechanism 70 from the right, FIG. 6 is a view of the extendable mechanism 70 from the left, and FIG. 7 is a perspective view of the extendable mechanism 70.

As illustrated in FIGS. 5 to 7, according to the present example, the extendable mechanism 70 includes a pair of lower right and left X-shaped arms (a lower left X-shaped arm 71L and a lower right X-shaped arm 71R) and a pair of upper right and left X-shaped arms (an upper left X-shaped arm 75L and an upper right X-shaped arm 75R).

Each of the lower left X-shaped arm 71L and the lower right X-shaped arm 71R, which form the pair of lower right and left X-shaped arms, is formed by a lower inner arm and a lower outer arm that cross each other in the shape of the letter “X” in side view. The lower inner arm and the lower outer arm are coupled to each other in such a manner that these arms can mutually rotate. Specifically, according to the present example, the lower left X-shaped arm 71L is formed by a lower inner arm 72L and a lower outer arm 74L, and the center portions thereof are rotatably attached to each other near the left end of a lower coupling shaft 81 extending laterally (see FIGS. 6 and 7). Similarly, the lower right X-shaped arm 71R is formed by a lower inner arm 72R and a lower outer arm 74R, and the center portions thereof are rotatably attached to each other near the right end of the lower coupling shaft 81 (see FIGS. 5 and 7).

Each of the upper left X-shaped arm 75L and the upper right X-shaped arm 75R, which form the pair of upper right and left X-shaped arms, is formed by an upper inner arm and an upper outer arm that cross each other in the shape of the letter “X” in side view. The upper inner arm and the upper outer arm are coupled to each other in such a manner that these arms can mutually rotate. Specifically, according to the present example, the upper left X-shaped arm 75L is formed by an upper inner arm 76L and an upper outer arm 78L, and the center portions thereof are rotatably attached to each other near the left end of an upper coupling shaft 82 extending laterally above the lower coupling shaft 81 (see FIGS. 6 and 7). Similarly, the upper right X-shaped arm 75R is formed by an upper inner arm 76R and an upper outer arm 78R, and the center portions thereof are rotatably attached to each other near the right end of the upper coupling shaft 82 (see FIGS. 5 and 7).

In addition, the pair of lower right and left X-shaped arms (the lower left X-shaped arm 71L and the lower right X-shaped arm 71R) and the pair of upper right and left X-shaped arms (the upper left X-shaped arm 75L and the upper right X-shaped arm 75R) are coupled to each other via a rear coupling shaft 83 and a front coupling shaft 84 extending laterally.

Specifically, according to the present example, the rear end of the lower inner arm 72L of the lower left X-shaped arm 71L and the rear end of the upper outer arm 78L of the upper left X-shaped arm 75L are rotatably attached to each other near the left end of the rear coupling shaft 83 (see FIGS. 6 and 7). The rear end of the lower inner arm 72R of the lower right X-shaped arm 71R and the rear end of the upper outer arm 78R of the upper right X-shaped arm 75R are rotatably attached to each other near the right end of the rear coupling shaft 83 (see FIGS. 5 and 7).

In addition, the front end of the lower outer arm 74L of the lower left X-shaped arm 71L and the front end of the upper inner arm 76L of the upper left X-shaped arm 75L are rotatably attached to each other near the left end of the front coupling shaft 84 (see FIGS. 6 and 7). The front end of the lower outer arm 74R of the lower right X-shaped arm 71R and the front end of the upper inner arm 76R of the upper right X-shaped arm 75R are rotatably attached to each other near the right end of the front coupling shaft 84 (see FIGS. 5 and 7).

The front end of the lower inner arm 72L of the lower left X-shaped arm 71L is rotatably attached inside the left end of a lower movable shaft 85, which extends laterally below the front coupling shaft 84 and is movable longitudinally (see FIGS. 6 and 7). The front end of the lower inner arm 72R of the lower right X-shaped arm 71R is rotatably attached inside the right end of the lower movable shaft 85 (see FIGS. 5 and 7).

The left end of the lower movable shaft 85 is inserted into the left guide groove 33L, which extends longitudinally and is formed on the inner surface (surface on the side of the right plate 31R) of the left plate 31L. The right end of the lower movable shaft 85 is inserted into the right guide groove 33R, which pairs with the left guide groove 33L and is formed on the inner surface (surface on the side of the left plate 31L) of the right plate 31R (see FIGS. 1 and 3 to 7). That is, according to the present example, both ends of the lower movable shaft 85 are supported by the left guide groove 33L of the left plate 31L and the right guide groove 33R of the right plate 31R, and are movable longitudinally along the left guide groove 33L and the right guide groove 33R.

In addition, the rear end of the lower outer arm 74L of the lower left X-shaped arm 71L is rotatably fixed to the left attachment part 35L, which is formed to protrude from the inner surface of the left plate 31L, via a pin member P1. The rear end of the lower outer arm 74R of the lower right X-shaped arm 71R is rotatably fixed to the right attachment part 35R, which corresponds to the left attachment part 35L and is formed to protrude from the inner surface of the right plate 31R, via a pin member P1 (see FIGS. 2 to 7).

The front end of the upper outer arm 78L of the upper left X-shaped arm 75L is rotatably attached inside the left end of an upper movable shaft 86, which extends laterally above the front coupling shaft 84 and is movable longitudinally (see FIGS. 6 and 7). The front end of the upper outer arm 78R of the upper right X-shaped arm 75R is rotatably attached inside the right end of the upper movable shaft 86 (see FIGS. 5 and 7).

The left end of the upper movable shaft 86 is inserted into the rail groove of the left rail member 55L, which extends longitudinally and is formed on the bottom surface of the lifting platform 50 (the top board part 51). The right end of the upper movable shaft 86 is inserted into the rail groove of the right rail member 55R, which pairs with the left rail member 55L (see FIGS. 1 and 3 to 7). That is, according to the present example, both ends of the upper movable shaft 86 are supported by the left rail member 55L and the right rail member 55R formed on the lifting platform 50, and are movable longitudinally along the rail groove of the left rail member 55L and the rail groove of the right rail member 55R.

In addition, the rear end of the upper inner arm 76L of the upper left X-shaped arm 75L is rotatably fixed to the left attachment part 57L formed to vertically extend on the bottom surface of the lifting platform 50 (the top board part 51) via a pin member P2. The rear end of the upper inner arm 76R of the upper right X-shaped arm 75R is rotatably fixed to the right attachment part 57R, which corresponds to the left attachment part 57L and is formed to vertically extend on the bottom surface of the lifting platform 50 (the top board part 51), via a pin member P2 (see FIGS. 2 to 7).

The drive device 90 is installed on an approximate center portion in a lateral direction on the top surface of the base 30. The drive device 90 vertically extends and retracts the pair of lower right and left X-shaped arms (the lower left X-shaped arm 71L, the lower right X-shaped arm 71R) and the pair of upper right and left X-shaped arms (the upper left X-shaped arm 75L, the upper right X-shaped arm 75R) of the extendable mechanism 70. In this way, the drive device 90 raises and lowers the lifting platform 50.

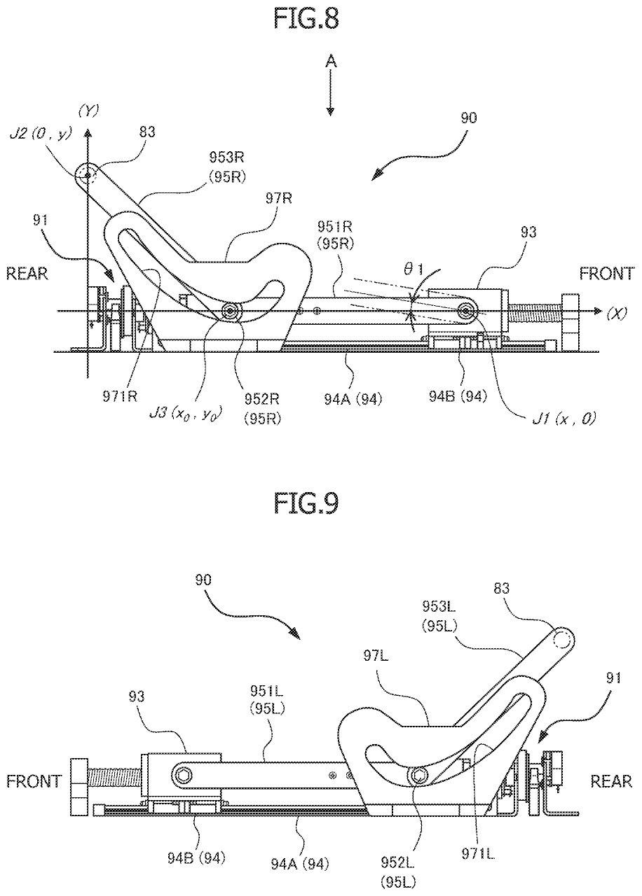

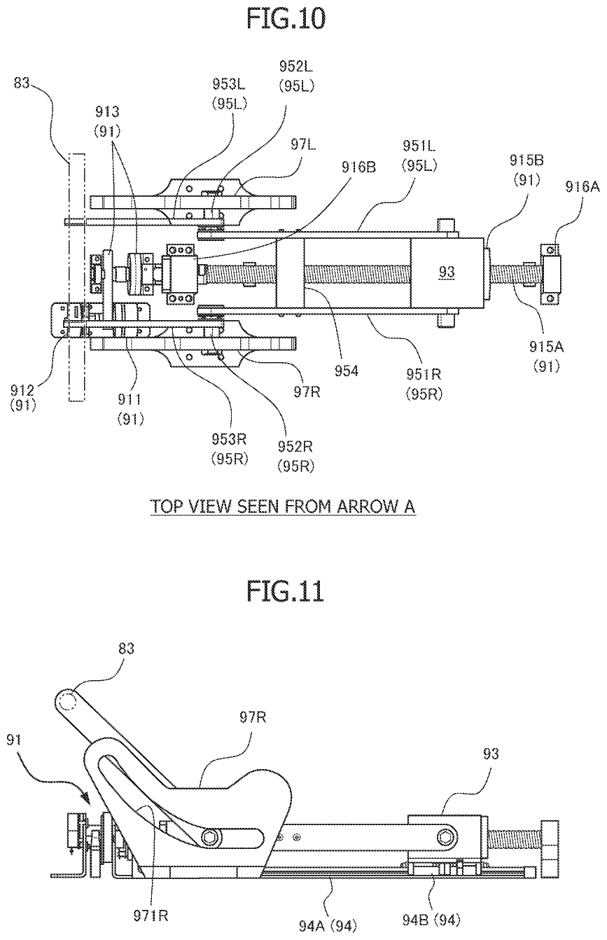

FIGS. 8 to 10 illustrate the construction of the drive device 90. FIG. 8 is a view of the drive device 90 from the right, FIG. 9 is a view of the drive device 90 from the left, and FIG. is a top view seen from an arrow A in FIG. 8.

As illustrated in FIGS. 8 to 10, according to the present example, the drive device 90 includes an electric actuator 91, a movable part 93 that is driven and moved by the electric actuator 91, and a pair of right and left link mechanisms (a left link mechanism 95L and a right link mechanism 95R) and a pair of right and left guide members (a left guide member 97L and a right guide member 97R) used as a coupling mechanism for coupling the movable part 93 and the extendable mechanism 70.

The electric actuator 91 is a linear actuator that converts the rotational motion of the electric motor into linear motion by using a linear motion mechanism (for example, a ball screw mechanism) and outputs the linear motion. According to the present example, the electric actuator 91 includes an electric motor (a servo motor) 911, a speed reduction mechanism 913, and a linear motion mechanism (a linear motion shaft (a screw shaft) 915A and a linear motion nut 915B).

The operation of the electric motor 911 is controlled by the control device 100. The control device 100 is installed at a predetermined position on the top surface of the base 30 (see FIGS. 1, 2, and 4). A non-excited brake 912 is attached to the output shaft of the electric motor 911, for example, via a coupling.

The speed reduction mechanism 913 reduces the speed of the rotation of the output shaft of the electric motor 911 and transfers the resultant rotation to the linear motion shaft 915A of the linear motion mechanism. The construction, etc., of the speed reduction mechanism 913 is not limited to any particular construction, etc. In addition, for example, the number of stages of the speed reduction mechanism 913 is not limited to any particular number.

The linear motion shaft 915A extends longitudinally and is rotatably supported by supporting members 916A and 916B to which a bearing (not illustrated) is attached. The linear motion shaft 915A is rotated by the electric motor 911 via the speed reduction mechanism 913. The linear motion nut 915B is threadably mounted on the linear motion shaft 915A and moves in the axial direction on the linear motion shaft 915A along with the rotation of the linear motion shaft 915A (that is, the linear motion nut 915B moves linearly and longitudinally).

The movable part 93 is fixed to the linear motion nut 915B and moves with the linear motion nut 915B. According to the present example, a linear slider 94 is installed below the linear motion shaft 915A. The linear slider 94 includes a slide rail 94A extending longitudinally and a slide block 94B moving on the slide rail 94A. The lower part of the movable part 93 fixed to the linear motion nut 915B is fixed to the slide block 94B.

The left link mechanism 95L and the right link mechanism 95R are constructed to push and pull the rear coupling shaft 83 of the extendable mechanism 70 along with the movement of the movable part 93. Consequently, the left link mechanism 95L and the right link mechanism 95R vertically extend and retract the pair of lower right and left X-shaped arms (the lower left X-shaped arm 71L and the lower right X-shaped arm 71R) and the pair of upper right and left X-shaped arms (the upper left X-shaped arm 75L and the upper right X-shaped arm 75R).

Specifically, according to the present example, the left link mechanism 95L includes a first link member 951L of which the front end is rotatably coupled to the left side of the movable part 93 and a second link member 953L of which the rear end is rotatably coupled to the rear coupling shaft 83 of the extendable mechanism 70 (that is, the pair of lower right and left X-shaped arms 71L and 71R and the pair of upper right and left X-shaped arms 75L and 75R) and of which the front end is rotatably coupled to the rear end of the first link member 951L via a shaft member 952L. Similarly, the right link mechanism 95R includes a first link member 951R of which the front end is rotatably coupled to the right side of the movable part 93 and a second link member 953R of which the rear end is rotatably coupled to the rear coupling shaft 83 of the extendable mechanism 70 and of which the front end is rotatably coupled to the rear end of the first link member 951R via a shaft member 952R. The first link member 951L of the left link mechanism 95L and the first link member 951R of the right link mechanism 95R are coupled to each other via a coupling plate 954.

The left guide member 97L and the right guide member 97R are disposed behind the top surface of the base 30, and are disposed on the left side and the right side of the electric actuator 91. The left guide member 97L has a guide hole 971L for guiding the shaft member 952L of the left link mechanism 95L that moves with the movement of the movable part 93. In addition, the right guide member 97R has a guide hole 971R for guiding the shaft member 952R of the right link mechanism 95R that moves with the movement of the movable part 93. The guide hole 971L in the left guide member 97L and the guide hole 971R in the right guide member 97R are formed to have the same shape.

For example, the shape of the guide hole 971L in the left guide member 97L and the guide hole 971R in the right guide member 97R are determined as follows. Hereinafter, although the shape of the guide hole 971R in the right guide member 97R will be described with reference to FIG. 8, the following description also applies to the shape of the guide hole 971L in the left guide member 97L.

First, when the lifting platform 50 is raised or lowered between its lowest position and its highest position, a first coupling part J1, at which the movable part 93 and the front end of the first link member 951R are coupled to each other, moves on the X axis, and a second coupling part J2, at which the second link member 953R and the rear coupling shaft 83 coupled to each other, moves on the Y axis (see FIG. 8).

Next, a relationship between the position (x,0) of the first coupling part J1 and the position (0,y) of the second coupling part J2, that is, a relationship between x and y, is determined by a physical law (herein, principle of virtual work). The relationship between y and x (for example, dy/dx) may be expressed by a constant or may be a linear or non-linear relationship. The present example assumes that the relationship (dy/dx) between y and x is expressed by a constant. Therefore, as will be described below, when the lifting platform 50 is raised from its lowest position to its highest position, the electric actuator 91 maintains its output at approximately the same level.

Next, a displacement angle θ1 (an angle from the X axis) of the first link member 951R is determined based on the inverse kinematics or the geometrical relationship of the mechanism, specifically, based on the relationship among the position (x,0) of the first coupling part J1, a length L1 of the first link member 951R, the position (0,y) of the second coupling part J2, and a length L2 of the second link member 953R.

Next, the position (x0,y0) of a center J3 of the shaft member 952R is determined based on the position (x,0) of the first coupling part J1, the length L1 of the first link member 951R, and the displacement angle θ1 of the first link member 951R. By connecting the determined position (x0,y0) of the center J3 of the shaft member 952R, the shape of the guide hole 971R is determined. There are two solutions for the displacement angle θ1 of the first link member 951R (there are two possible values for the displacement angle θ1). The present example adopts the smaller one of the two solutions (the two values) for the displacement angle θ1 of the first link member 951R, mainly to minimize the size of the guide holes 971L and 971R. As a result, the guide holes 971L and 971R have the shapes as illustrated in FIGS. 8, 9, etc.

The guide hole 971R is formed to have a curved shape such that the shaft member 952R can be smoothly moved therein. In the present example, the guide hole 971R is formed to have a curved shape approximately like the letter “U” (or “V”). In this way, when the movable part 93 is moved in the direction that raises the lifting platform 50, the shaft member 952L (952R) is first moved diagonally downward in the rear direction, and is next moved diagonally upward in the rear direction. However, the present invention is not limited to this example. The shape of the guide hole 971R varies depending on the length L1 of the first link member 951R and the length L2 of the second link member 953R. For example, as illustrated in FIG. 11, the guide hole 971R may be formed such that the shaft member 952R will be first moved horizontally in the rear direction and next moved diagonally upward.

The control device 100 controls the electric motor 911 of the electric actuator 91 based on the operation commands that are input via an input unit (not illustrated). In the present example, examples of the operation commands include an up command for raising the lifting platform 50, a down command for lowering the lifting platform 50, and a stop command for stopping the raising or lowering of the lifting platform 50. Upon receiving the up command, the control device 100 rotates the electric motor 911 in a first direction (this rotation will be hereinafter referred to as “normal rotation”). Upon receiving the down command, the control device 100 rotates the electric motor 911 in a second direction opposite to the first direction (this rotation will be hereinafter referred to as “reverse rotation”). In addition, upon receiving the stop command, the control device 100 controls the electric motor 911 such that the lifting platform 50 is held at its current vertical position.

Next, an operation example of the lifting apparatus 10 will be described.

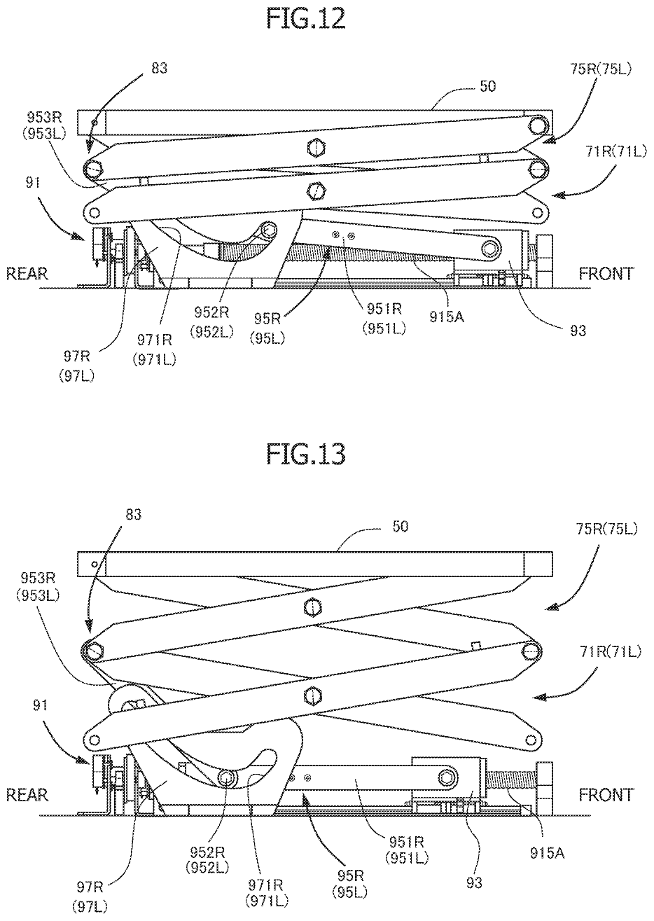

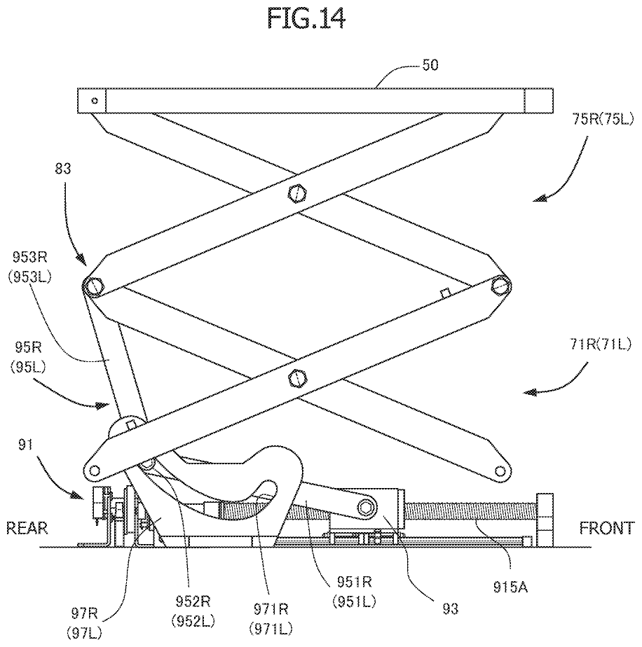

FIG. 12 illustrates the state of the extendable mechanism 70 and the drive device 90 when the lifting platform 50 is located at its lowest position. FIG. 13 illustrates the state of the extendable mechanism 70 and the drive device 90 when the lifting platform 50 is located at an intermediate position. FIG. 14 illustrates the state of the extendable mechanism 70 and the drive device 90 when the lifting platform 50 is located at its highest position.

In addition, for example, when the lifting platform 50 is located at its lowest position, if the up command is input by the operator via the input unit, the control device 100 causes the electric motor 911 of the electric actuator 91 to perform the normal rotation. Accordingly, the movable part 93 is moved backward, and the rear coupling shaft 83 of the extendable mechanism 70 is raised by the left link mechanism 95L and the right link mechanism 95R. As a result, the pair of lower right and left X-shaped arms (the lower left X-shaped arm 71L and the lower right X-shaped arm 71R) and the pair of upper right and left X-shaped arms (the upper left X-shaped arm 75L and the upper right X-shaped arm 75R), extends upward, and the lifting platform 50 is consequently raised. When the lifting platform 50 reaches its highest position, the control device 100 stops the normal rotation of the electric motor 911 of the electric actuator 91 to hold the lifting platform 50 at its highest position (FIG. 12→FIG. 13→FIG. 14).

In addition, for example, when the lifting platform 50 is located at its highest position, if the down command is input by the operator via the input unit, the control device 100 causes the electric motor 911 of the electric actuator 91 to perform the reverse rotation. Accordingly, the movable part 93 is moved forward, and the rear coupling shaft 83 of the extendable mechanism 70 is lowered by the left link mechanism 95L and the right link mechanism 95R. As a result, the pair of lower right and left X-shaped arms (the lower left X-shaped arm 71L and the lower right X-shaped arm 71R) and the pair of upper right and left X-shaped arms (the upper left X-shaped arm 75L and the upper right X-shaped arm 75R) retract downward, and the lifting platform 50 is consequently lowered. When the lifting platform 50 reaches its lowest position, the control device 100 stops the reverse rotation of the electric motor 911 of the electric actuator 91 (FIG. 14→FIG. 13→FIG. 12).

When the lifting platform 50 has been raised or lowered to an intermediate position, if the stop command is input by the operator via the input unit, the control device 100 stops the normal rotation or the reverse rotation of the electric motor 911 of the electric actuator 91 to hold the lifting platform 50 at its current vertical position (the intermediate position) (FIG. 13).

In the present example, the non-excited brake 912 is attached to the output shaft of the electric motor 911 of the electric actuator 91. Thus, even when the power supply to the electric actuator 91 (the electric motor 911) is stopped, the lifting platform 50 is held at its current position.

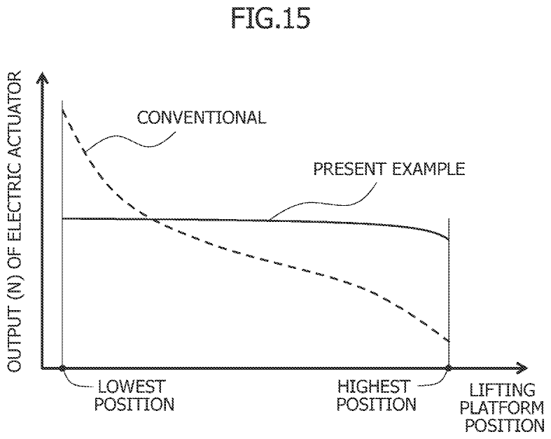

FIG. 15 illustrates an example of a result of a comparison between the lifting apparatus according to the present example and a conventional lifting apparatus of the same kind. Specifically, FIG. 15 illustrates the outputs of the electric actuators of these lifting apparatuses when their respective lifting platforms on which a load is placed are raised from their lowest position to their highest position.

In the case of the conventional lifting apparatus of the same kind, as indicated by a dashed line in FIG. 15, the output of the electric actuator for raising the lifting platform located at its lowest position is at its maximum level, and next, the output of the electric actuator decreases as the lifting platform is raised. In contrast, in the case of the lifting apparatus 10 according to the present example, the output of the electric actuator for raising the lifting platform located at its lowest position is less than that of the conventional lifting apparatus of the same kind. In addition, the output F of the electric actuator 91 is held at approximately the same level during the raising of the lifting platform 50 from its lowest position to its highest position. Accordingly, the lifting platform 50 is raised from its lowest position to its highest position at a constant speed.

As described above, the drive device 90 of the lifting apparatus 10 according to the present example raises and lowers the lifting platform 50 by vertically extending and retracting the pair of lower right and left X-shaped arms and the pair of upper right and left X-shaped arms. The drive device 90 includes the electric actuator 91, the movable part 93 driven and moved by the electric actuator 91, the pair of right and left link mechanisms (the left link mechanism 95L and the right link mechanism 95R), and the pair of right and left guide members (the left guide member 97L and the right guide member 97R).

The left link mechanism 95L (the right link mechanism 95R) includes a first link member 951L (951R) of which the front end is rotatably coupled to the movable part 93 and a second link member 953L (953R) of which the rear end is rotatably coupled to the rear coupling shaft 83 of the extendable mechanism 70 (that is, the pair of lower right and left X-shaped arms and the pair of upper right and left X-shaped arms) and of which the front end is rotatably coupled to the rear end of the first link member 951L (951R) via a shaft member 952L (952R). In addition, the left guide member 97L (the right guide member 97R) has the guide hole 971L (the guide hole 971R) for guiding the shaft member 952L (the shaft member 952R) that moves with the movement of the movable part 93. The guide hole 971L (971R) has a curved shape such that the shaft member 952L (952R) can be smoothly moved therein.

The drive device 90 controls the electric actuator 91 such that the movable part 93 is moved longitudinally. With this movement of the movable part 93, the rear coupling shaft 83 of the extendable mechanism 70 is pushed or pulled by the first link member 951L (951R) and the second link member 953L (953R). In this way, because the pair of upper right and left X-shaped arms and the pair of lower right and left X-shaped arms are extended or retracted vertically, the lifting platform 50 is consequently raised or lowered.

The electric actuator 91 of the lifting apparatus 10 according to the present example needs a lower output for raising the lifting platform 50 located at its lowest position than the output needed by the electric actuator of the conventional lifting apparatus 10 of the same kind. In addition, the fluctuation of the output of the electric actuator 91 needed to raise the lifting platform 50 is reduced (see FIG. 15). Therefore, because the electric actuator 91 (the electric motor 911) can have a smaller size than conventional electric actuators, the cost of the lifting apparatus 10 can be reduced. In addition, the fluctuation in the rate of raising and lowering the lifting platform 50 can be reduced.

In the example described above, the extendable mechanism 70 is formed as an X-shaped link mechanism in which two right X-shaped arms are vertically stacked one on the other and two left X-shaped arms are vertically stacked one on the other. However, the present invention is not limited to this example. The extendable mechanism 70 may be formed as an X-shaped link mechanism having a pair of right and left X-shaped arms in one stage or in three or more stages.

In addition, in the example described above, the left guide member 97L has the guide hole 971L for guiding the shaft member 952L of the left link mechanism 95L that moves with the movement of the movable part 93, and the right guide member 97R has the guide hole 971R for guiding the shaft member 952R of the right link mechanism 95R that moves with the movement of the movable part 93. However, the present invention is not limited to this example. The left guide member 97L may have a guide groove instead of the guide hole 971L, and/or the right guide member 97R may have a guide groove instead of the guide hole 971R.

In addition, in the example described above, the electric actuator 91 is formed as a linear actuator that converts the rotational motion of the electric motor into linear motion by using a linear motion mechanism (for example, a ball screw mechanism) and outputs the linear motion. However, the present invention is not limited to this example. The electric actuator 91 may be any electric actuator that moves the movable part 93 linearly and longitudinally.

In addition, in the above-described example, the relationship (dy/dx) between y and x for determining the shape of the guide holes 971L and 971R is expressed by a constant. However, the present invention is not limited to this example. As described above, the relationship (dy/dx) between y and x may be a linear or a non-linear relationship. If the relationship between y and x varies, the shape of the guide holes 971L and 971R varies. If the shape of the guide holes 971L and 971R varies, the output of the electric actuator 91 that is needed to raise the lifting platform 50 and the raising speed of the lifting platform 50 vary. In other words, the raising characteristics of the lifting platform 50 can be changed based on the shape of the guide holes 971L and 971R. Therefore, the lifting apparatus 10 according to the example is advantageous in that demands about the raising characteristics of the lifting platform 50 can be accommodated relatively flexibly.

In addition, in the example described above, the drive device 90 controls, with this movement of the movable part 93, pushing or pulling the rear coupling shaft 83 via the first link member 951L (951R) and the second link member 953L (953R). In this way, the pair of upper right and left X-shaped arms and the pair of lower right and left X-shaped arms are extended or retracted vertically. However, the present invention is not limited to this example. The drive device 90 may push or pull the front coupling shaft 84 instead of the rear coupling shaft 83. In this way, the drive device 90 may vertically extend and retract the pair of lower right and left X-shaped arms and the pair of upper right and left X-shaped arms.

Although examples and modifications of the present invention have thus been described, the present invention is not limited thereto. Further variations and modifications are of course possible based on the basic technical concepts of the present invention.

### REFERENCE SYMBOL LIST

10 Lifting apparatus
30 Base
50 Lifting platform
70 Extendable mechanism
71L Lower left X-shaped arm
71R Lower right X-shaped arm
72L, 72R Lower inner arm
74L, 74R Lower outer arm
75L Upper left X-shaped arm
75R Upper right X-shaped arm
76L, 76R Upper inner arm
78L, 78R Upper outer arm
81 Lower coupling shaft
82 Upper coupling shaft
83 Rear coupling shaft
84 Front coupling shaft
85 Lower movable shaft
86 Upper movable shaft
90 Drive device
91 Electric actuator
93 Movable part
94 Linear slider
95L Left link mechanism
95R Right link mechanism
97L Left guide member
97R Right guide member
911 Electric motor
913 Speed reduction mechanism
915A Linear motion mechanism (screw shaft)
915B Linear motion nut
951L, 951R First link member
952L, 952R Shaft member
953L, 953R Second link member
971L, 971R Guide hole (guide part)

1. A lifting apparatus that raises and lowers a lifting platform by vertically extending and retracting a pair of right and left X-shaped arms with a drive device,
the drive device comprising:
an electric actuator;
a movable part that is driven and moved by the electric actuator;
a first link member having one end that is rotatably coupled to the movable part;
a second link member having one end that is rotatably coupled to the pair of right and left X-shaped arms and having another end that is rotatably coupled to another end of the first link member via a shaft member; and
a guide member having a guide part for guiding the shaft member that moves with movement of the movable part,
wherein the drive device is constructed to vertically extend and retract the pair of right and left X-shaped arms via the first link member and the second link member along with movement of the movable part.

2. The lifting apparatus according to claim 1,
wherein each of the pair of X-shaped arms is formed by an inner arm and an outer arm that cross each other in the shape of the letter “X” in side view and that are coupled to each other in such a manner that these arms can mutually rotate,
wherein the pair of right and left X-shaped arms are constructed to have an end of the right inner arm and an end of the left inner arm or an end of the right outer arm and an end of the left outer arm rotatably attached near both ends of a coupling shaft that extends laterally,
wherein the one end of the second link member is rotatably coupled to the coupling shaft, and
wherein the drive device is constructed to extend the pair of right and left X-shaped arms upward by raising the coupling shaft via the first link member and the second link member along with movement of the movable part, and to retract the pair of right and left X-shaped arms downward by lowering the coupling shaft via the first link member and the second link member along with movement of the movable part.

3. The lifting apparatus according to claim 1, wherein the movable part moves linearly and longitudinally.

4. The lifting apparatus according to claim 3, wherein the guide part is formed such that the shaft member is first moved horizontally or diagonally downward and is next moved diagonally upward as the movable part is moved in a direction that raises the lifting platform.

5. The lifting apparatus according to claim 1,
wherein the electric actuator includes an electric motor, a linear motion shaft that is rotated by the electric motor via a speed reduction mechanism, and a linear motion nut that moves in an axial direction of the linear motion shaft along with the rotation of the linear motion shaft, and
wherein the movable part is integrally formed with the linear motion nut.

6. The lifting apparatus according to claim 1, wherein the pair of right and left X-shaped arms are provided in a plurality of stages and are vertically stacked one on another.
